(19) United States
(12) Patent Application Publication
(10) Pub. No.: US 2018/0144894 A1
(43) Pub. Date: May 24, 2018

(54) CONTACT DEVICE AND ELECTROMAGNETIC CONTACT APPARATUS USING SAME

(71) Applicant: FUJI ELECTRIC FA COMPONENTS & SYSTEMS CO., LTD., Tokyo (JP)

(72) Inventors: Kouetsu TAKAYA, Kounosu (JP); Yuki Tashima, Kitamoto (JP); Hideo Adachi, Fukaya (JP); Yasuhiro Naka, Kitamoto (JP); Yuya Sakurai, Kounosu (JP)

(73) Assignee: FUJI ELECTRIC FA COMPONENTS & SYSTEMS CO., LTD., Tokyo (JP)

(21) Appl. No.: 15/876,267

(22) Filed: Jan. 22, 2018

Related U.S. Application Data
(63) Continuation of application No. PCT/JP2017/002720, filed on Jan. 26, 2017.

(30) Foreign Application Priority Data
Jan. 27, 2016 (JP) 2016-013587

(51) Int. Cl. H01H 50/14; H01H 50/54; H01H 50/36; H01H 50/02

(52) U.S. Cl. CPC H01H 50/14; H01H 50/541; H01H 2235/01; H01H 50/02; H01H 2205/002; H01H 50/36

(57) ABSTRACT

A contact device and an electromagnetic contactor using the contact device. The contact device has: a main contact including a pair of fixed contact elements arranged at a predetermined distance from each other and a movable contact element elastically supported by a connecting shaft and arranged to be contactable with and separable from the pair of fixed contact elements; an auxiliary contact arranged at a position different from the main contact and including a pair of fixed contacts arranged at a predetermined distance from each other and a movable contact connected to the connecting shaft and arranged to be contactable with and separable from the pair of fixed contacts; a contact housing configured to house the main contact and the auxiliary contact; and external connection terminals electrically connected to the pair of fixed contacts of the auxiliary contact and projecting from the contact housing.

### CROSS-REFERENCE TO RELATED APPLICATIONS

This application is a continuation application, under 35 U.S.C. § 111(a), of international application No. PCT/JP2017/002720, filed Jan. 26, 2017, which is based on and claims foreign priority to Japanese patent application No. 2016-013587, filed Jan. 27, 2016, the entire disclosures of which are herein incorporated by reference as a part of this application.

### TECHNICAL FIELD

The present invention relates to a contact device that opens and closes a current path and an electromagnetic contactor using the contact device.

### BACKGROUND ART

As contact devices that open and close a current path, for example, those disclosed in PTL 1 and 2 are conventionally known.

The contact device disclosed in PTL 1 includes a main contact unit and an auxiliary contact unit. However, the main contact unit and the auxiliary contact unit are not connected to each other. Thus, there is a problem in that, for example, when welding occurs in the main contact unit, the welding cannot be detected by the auxiliary contact unit.

Additionally, in the contact device disclosed in PTL 2, a main contact unit and an auxiliary contact unit are supported by a connecting shaft and driven by an electromagnet unit. Thus, when welding occurs in the main contact unit, the welding can be detected by the auxiliary contact unit.

### CITATION LIST

### Patent Literature

PTL 1: U.S. Pat. No. 7,944,333

PTL 2: JP 2013-232340 A

### SUMMARY OF INVENTION

### Technical Problems

On the other hand, in the contact device disclosed in PTL 2, a movable contact element of the main contact unit and a movable contact element holding portion of the auxiliary contact unit are arranged to be orthogonal to each other, and also, the main contact unit and the auxiliary contact unit are housed in different housing units. Thus, there is a problem in that it is difficult to draw out external connection terminals of the auxiliary contact unit upward while avoiding the movable contact element of the main contact unit.

Accordingly, the present invention has been made focusing on the problems of the conventional examples disclosed in PTL 1 and 2 described above. It is an object of the invention to provide a contact device that enables external connection terminals of an auxiliary contact unit to be drawn out upward while avoiding a main contact unit in a state where the main contact unit and the auxiliary contact unit are connected to a connecting shaft, and an electromagnetic contactor using the contact device.

### Solution to Problems

To achieve the above object, a contact device according to one aspect of the present invention includes a main contact unit including a pair of fixed contact elements arranged at a predetermined distance from each other and a movable contact element elastically supported by a movable shaft and arranged to be contactable with and separable from the pair of fixed contact elements, an auxiliary contact unit arranged at a position different from the main contact unit and including a pair of fixed contacts arranged at a predetermined distance from each other and a movable contact connected to the movable shaft and arranged to be contactable with and separable from the pair of fixed contacts, a contact housing case configured to house the main contact unit and the auxiliary contact unit, and an external connection terminal electrically connected to each of the pair of fixed contacts of the auxiliary contact and projecting from the contact housing case.

Additionally, an electromagnetic contactor according to one aspect of the present invention includes the contact device having the above structure, and includes an electromagnet unit in which the movable shaft is connected to a movable iron core to move the movable iron core.

### Advantageous Effects of Invention

According to one aspect of the contact device according to the present invention, there can be provided a contact device including an auxiliary contact, which enables the external connection terminal of the auxiliary contact unit to be drawn out upward from the contact housing unit while avoiding the movable contact element of the main contact unit in the state where the movable contact element of the main contact unit and the movable contact of the auxiliary contact unit are connected to the same connecting time, so that structure is simple and assembly is easy.

In addition, one aspect of the electromagnetic contactor according to the invention can provide an electromagnetic contactor including an auxiliary contact in the simple structure.

### BRIEF DESCRIPTION OF DRAWINGS

FIG. 1 is a front view illustrating a first embodiment of an electromagnetic contactor including a contact device according to the present invention;

FIG. 2 is a cross-sectional view of a main contact unit of the electromagnetic contactor of FIG. 1;

FIG. 3 is an exploded perspective view of the contact device included in the electromagnetic contactor of FIG. 1;

FIG. 4 is a cross-sectional view illustrating a first auxiliary contact mechanism of an auxiliary contact unit of the electromagnetic contactor of FIG. 1;

FIG. 5 is a cross-sectional view illustrating a second auxiliary contact mechanism of the auxiliary contact unit in the electromagnetic contactor of FIG. 1;

FIG. 6 is a cross-sectional view illustrating external connection terminals of the auxiliary contact unit of the electromagnetic contactor of FIG. 1;

FIG. 7 is a perspective view illustrating the electromagnetic contactor of FIG. 1 with a contact housing case thereof removed;

FIG. 8 is a perspective view illustrating external connection terminals of the auxiliary contact unit of the electromagnetic contactor of FIG. 7;

FIG. 9 is a perspective view illustrating a fixed contact and an external connection terminal of the auxiliary contact unit of the electromagnetic contactor of FIG. 8;

FIG. 10 is a perspective view cross-sectionally representing positions of external connection terminals illustrating a second embodiment of the contact device according to the invention;

FIG. 11 is a perspective view illustrating a fixed contact and an external connection terminal of FIG. 10;

FIG. 12 is a cross-sectional view of an electromagnetic contactor of FIG. 10 along a line XII-XII;

FIG. 13 is a perspective view cross-sectionally representing positions of external connection terminals illustrating a third embodiment of the contact device according to the invention;

FIG. 14 is a perspective view illustrating a fixed contact and an external connection terminal of an electromagnetic contactor of FIG. 13;

FIG. 15 is a cross-sectional view of an electromagnetic contactor of FIG. 13 along a line XV-XV;

FIG. 16 is a perspective view illustrating a fourth embodiment of the contact device according to the invention;

FIG. 17 is a cross-sectional view illustrating a main contact unit of the contact device of FIG. 16;

FIG. 18 is a perspective view cross-sectionally illustrating an auxiliary contact unit of the contact device of FIG. 16:

FIGS. 19A and 19B are schematic views illustrating a first embodiment;

FIGS. 20A and 20B are schematic views illustrating a fifth embodiment of the contact device according to the invention; and

FIG. 21 is a schematic view illustrating a sixth embodiment of the contact device according to the invention.

### DESCRIPTION OF EMBODIMENTS

Next, one embodiment of the present invention will be described with reference to the drawings. In the following description of the drawings, the same or similar parts are denoted by the same or similar reference signs. However, it is to be noted that the drawings are schematic and relationships between thicknesses and plane dimensions, ratios between thicknesses of respective layers, and the like are different from actual ones. Accordingly, note that specific thicknesses and dimensions should be determined in consideration of the description given below. In addition, it is obvious that there are partial differences in mutual dimensional relationships and ratios between the drawings.

Additionally, embodiments given below exemplify devices and methods that embody the technological concept of the present invention, and the technological concept of the invention do not limit materials, shapes, structures, arrangements, and the like of constituent components to those described below. Various changes can be added to the technological concept of the invention within the technological scope as defined by the appended claims.

Hereinafter, embodiments of an electromagnetic contactor including a contact device according to the invention will be described.

### First Embodiment

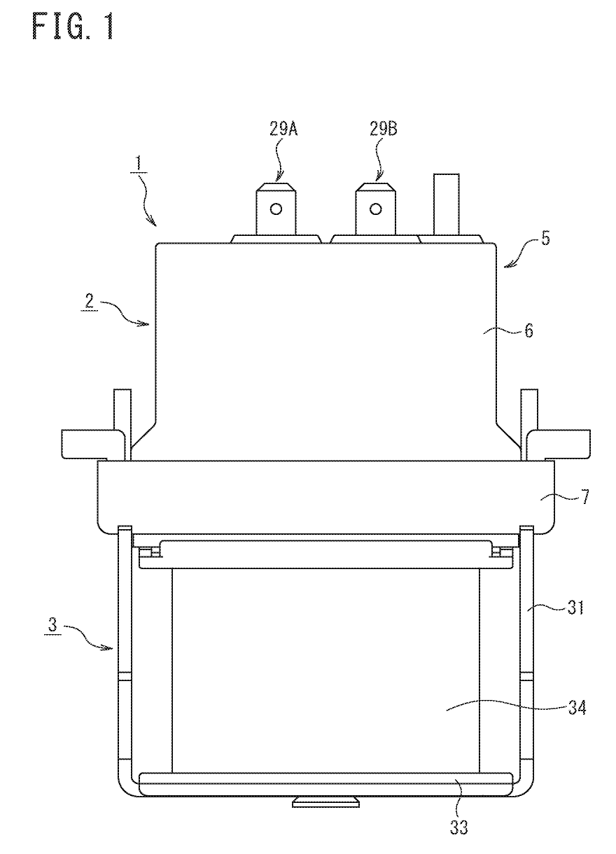

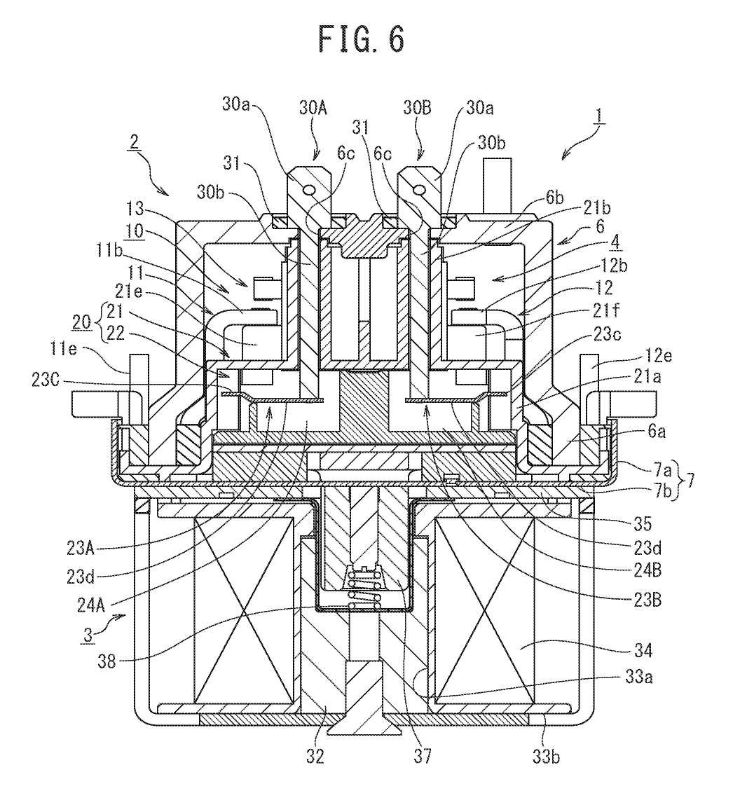

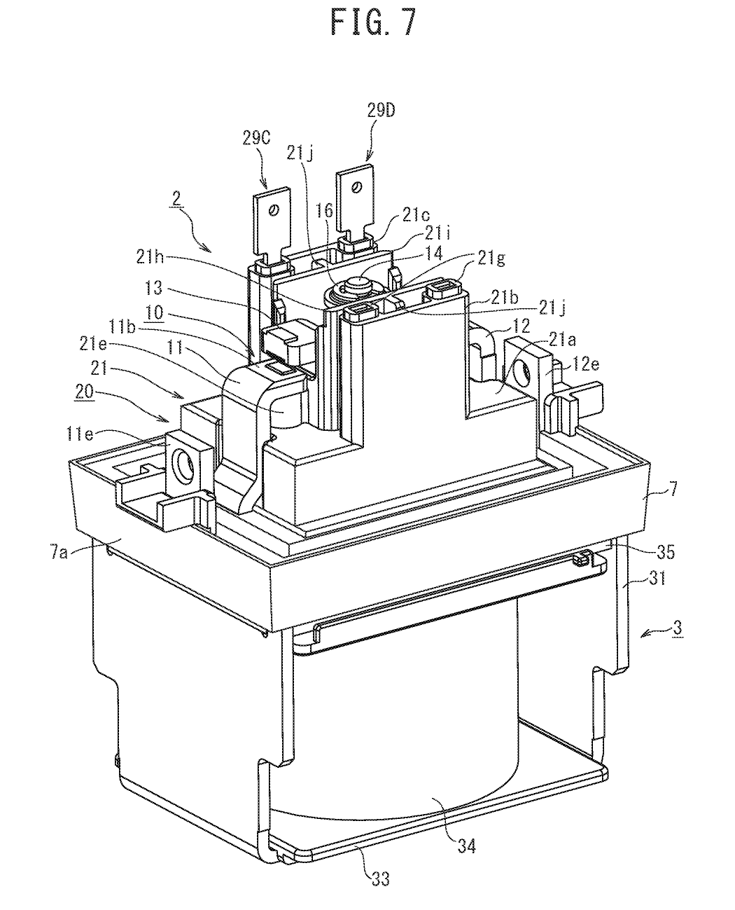

An electromagnetic contactor 1 includes a contact device 2 and an electromagnet unit 3 configured to drive the contact device 2, as illustrated in FIGS. 1 to 8.

The contact device 2 includes a contact housing unit 5 configured to house a contact mechanism 4. The contact housing unit 5 includes a bottomed upper rectangular cylindrical body 6 having an open one end, being relatively large in height, and made of an electrically insulating material and a bottomed lower rectangular cylindrical body 7 closing the open end of the bottomed upper rectangular cylindrical body 6 and being relatively small in height, e.g., serving as a metallic lid body.

The bottomed upper rectangular cylindrical body 6 is formed into a rectangular shape in plan view, and a bottom side of the cylindrical body 6 is formed into an extended cylindrical portion 6a having a shape wider in diameter at the bottom side. Additionally, on an upper surface plate portion 6b of the bottomed upper rectangular cylindrical body 6 are formed through-holes 6c that expose to an outside individually four external connection terminals of an auxiliary contact unit 20 that will be described later.

The bottomed lower rectangular cylindrical body 7 includes a rectangular cylindrical portion 7a that serves as a circumferential flange portion relatively small in height and a bottom plate portion 7b closing a bottom surface of the rectangular cylindrical portion 7a. The bottomed upper rectangular cylindrical body 6 and the bottomed lower rectangular cylindrical body 7 are sealed, in a state where the contact mechanism 4 is housed thereinside, by forming a first adhesive layer 8 by filling an adhesive between the extended cylindrical portion 6a of the bottomed upper rectangular cylindrical body 6 and the rectangular cylindrical portion 7a of the bottomed lower rectangular cylindrical body 7.

The contact mechanism 4 includes a main contact unit 10 and the auxiliary contact unit 20. The main contact unit 10 is configured to open and close a current path. The main contact unit 10 includes a pair of fixed contact elements 11 and 12 fixed at a predetermined distance from each other in a longitudinal direction at a center in a direction orthogonal to the longitudinal direction of the contact housing unit 5 and a movable contact element 13 arranged to be contactable with and separable from the pair of fixed contact elements 11 and 12 and extending in the longitudinal direction.

The pair of fixed contact elements 11 and 12, respectively, include an upper plate portion 11b, 12b having a fixed contact 11a, 12a formed on an upper surface thereof, a perpendicular plate portion 11c, 12c extending from an outer end of the upper plate portion 11b, 12b along an inner peripheral surface of the bottomed upper rectangular cylindrical body 6, a folded-back portion 11d, 12d folded back into a U-shape from a bottom portion of the perpendicular plate portion 11c, 12c, and a terminal portion 11e, 12e formed at a folded-back end of the folded-back portion 11d, 12d. Here, the upper plate portion 11b, 12b is supported by a contact receiving portion of an auxiliary contact case that will be described later.

The movable contact element 13 includes a recessed portion 13a formed at a center thereof and extended ends 13b and 13c extending outward from both longitudinal ends of the recessed portion 13a. On distal end-side lower surfaces of the extended ends 13b and 13c are formed movable contacts 13d and 13e at positions facing, from above, the fixed contacts 11a and 12a of the fixed contact elements 11 and 12. At a center of the recessed portion 13a of the movable contact element 13 is formed a through-hole 13f into which a connecting shaft 14 is inserted.

On the connecting shaft 14 is formed a flange portion 14a that holds a lower surface of the movable contact element 13, and on an upper surface side of the movable contact element 13 is arranged a contact spring 15. An upper end of the contact spring 15 is fixed by, for example, an E ring 17, mounted to an upper end of the connecting shaft 14 via a spring receiver 16. A lower end of the connecting shaft 14 is connected to a movable plunger 37 that will be described later. The movable contact element 13 is contacted with and separated from the pair of fixed contact elements 11, 12 by the movable plunger 37.

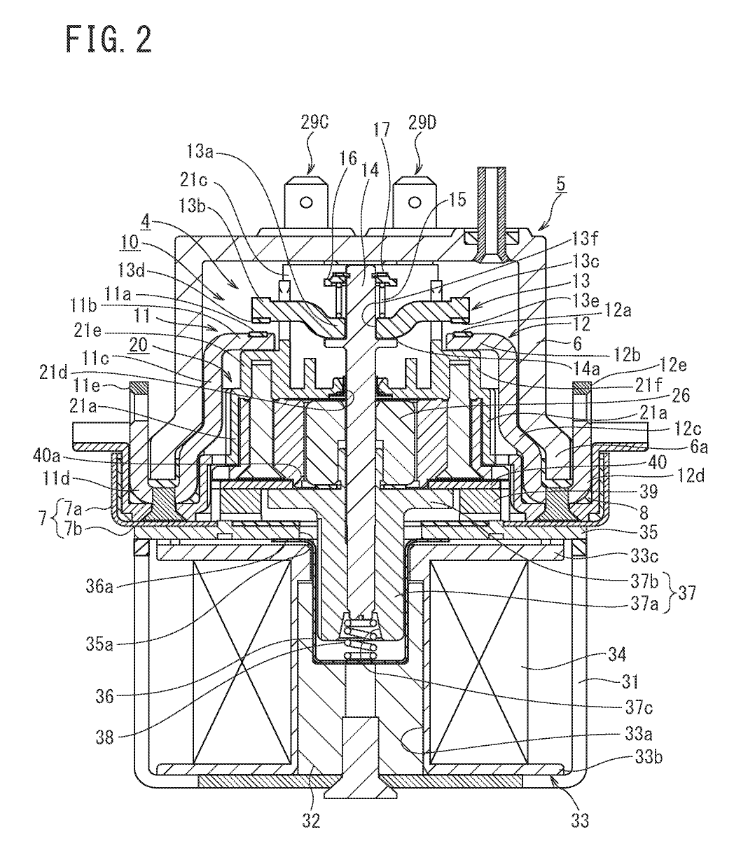

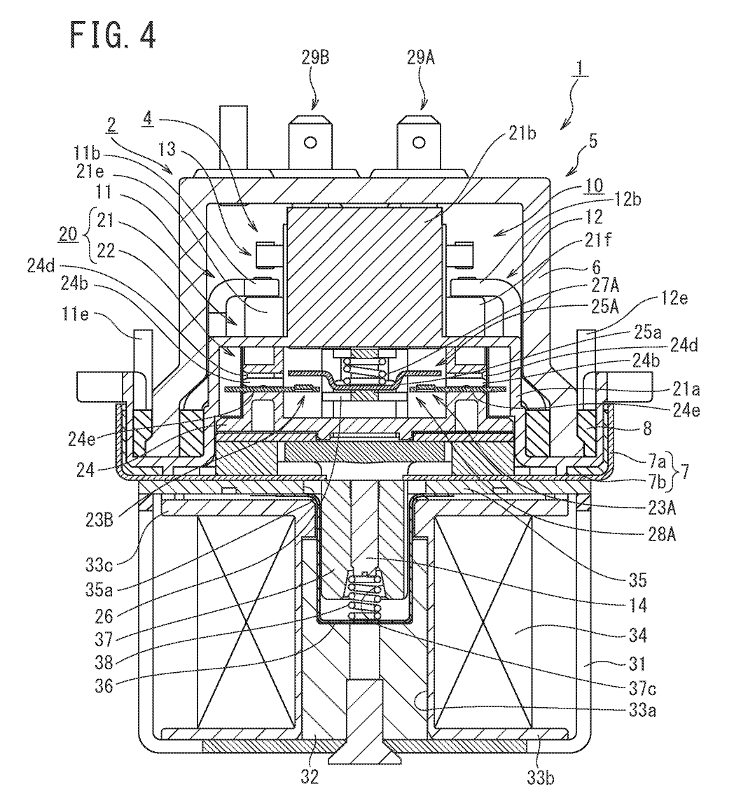

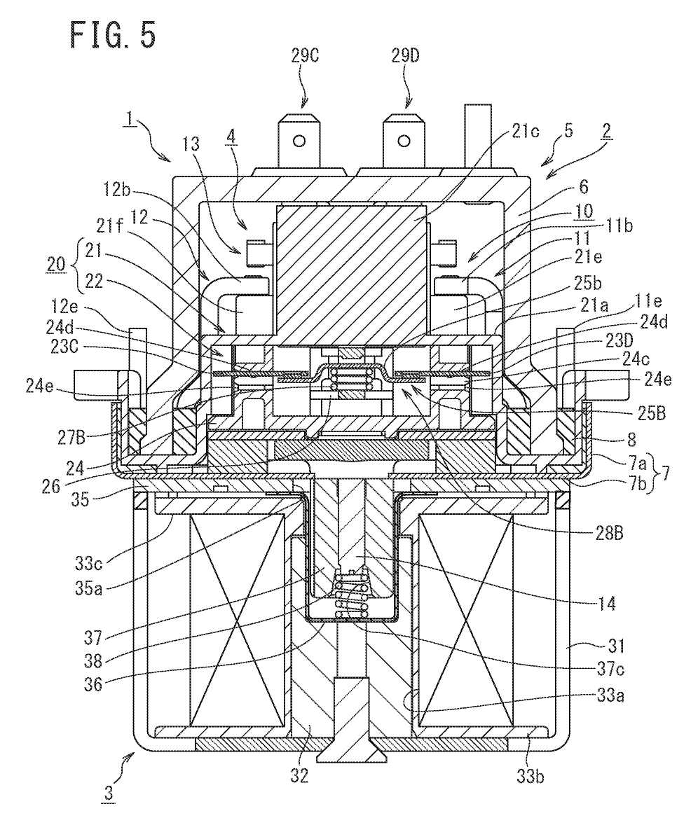

The auxiliary contact unit 20 includes an auxiliary contact case 21 made of an electrically insulating material such as a synthetic resin and an auxiliary contact mechanism 22 housed in the auxiliary contact case 21, as illustrated in FIGS. 4 and 5. The auxiliary contact case 21 is arranged below the upper plate portions 11b, 12b of the pair of fixed contact elements 11, 12 of the main contact unit 10, as illustrated in FIGS. 2, 4, 5, and 7. The auxiliary contact case 21 includes a contact housing unit 21a incorporating the auxiliary contact mechanism 22 and having a bottomed rectangular cylindrical shape whose lower end is open and a pair of terminal housing cylindrical portions 21b, 21c communicating with the contact housing unit 21a formed integrally therewith at positions interposing the pair of fixed contact elements 11, 12 and the movable contact element 13 of the main contact unit 10 on an upper surface side of the contact housing unit 21a therebetween.

In the contact housing portion 21a, at a center of the upper surface thereof in plan view is formed a through-hole 21d into which the connecting shaft 14 is inserted, as illustrated in FIG. 2. Additionally, on both longitudinal sides of the contact housing portion 21a with the through-hole 21d therebetween are formed a pair of cylindrical contact receiving portions 21e and 21f having closed upper surfaces on which the upper plate portions 11b, 12b of the pair of fixed contact elements 11, 12 are mounted.

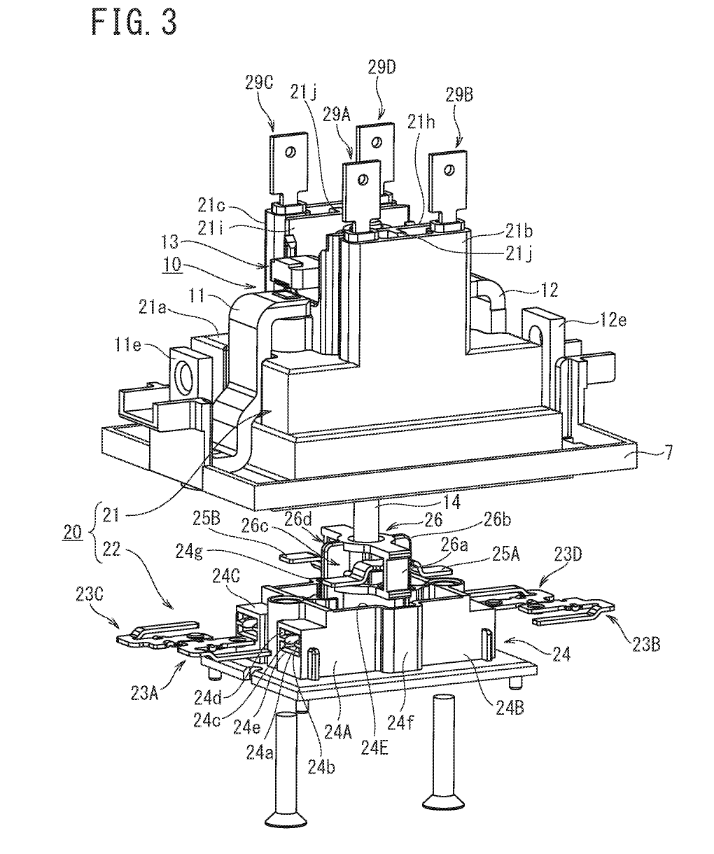

The auxiliary contact mechanism 22 is housed in the contact housing portion 21a. The auxiliary contact mechanism 22 includes a fixed contact holding portion 24 made of an electrically insulating material such as a synthetic resin and holding fixed contacts 23A to 23D formed of, e.g., a spring material and a movable contact support 26 holding movable contacts 25A, 25B, as illustrated in FIG. 3.

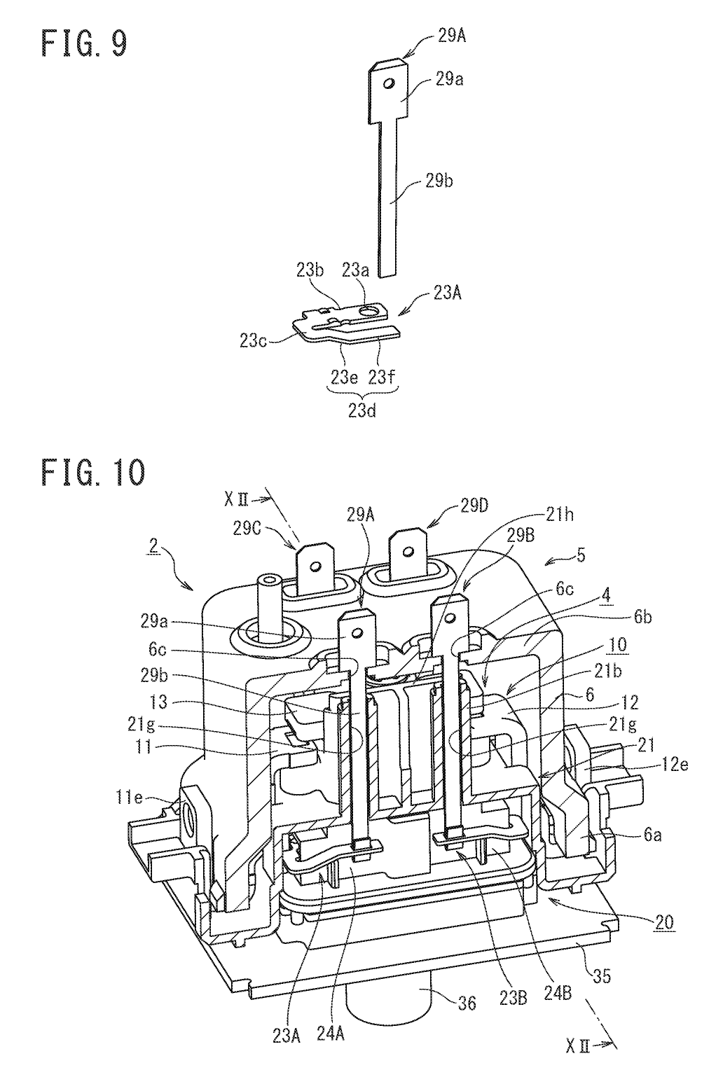

As illustrated in FIG. 9, the fixed contact 23A is formed into a U-shape by a contact base portion 23b as a first conductive plate portion that is composed of a rectangular plate portion extending outward from inward and having a contact portion 23a formed on a distal end upper surface thereof, a folded-back portion 23c as a connecting plate portion folded back from one end of the contact base portion 23b to forward while maintaining a predetermined distance, and an elastic plate portion 23d as a second conductive plate portion extending inward from a distal end of the folded-back portion 23c in parallel with the contact base portion 23b.

Here, in the folded-back portion 23c, a gap between inner peripheral edges thereof is set to a length such that the folded-back portion 23c is fitted into a sidewall forming the contact housing portion that will be described later. Additionally, as illustrated in FIG. 4, a plate width of the folded-back portion 23c is set to a width such that an outer end thereof closely faces an inner peripheral surface of a left wall of the contact housing portion 21a with a slight gap therebetween in a state where the folded-back portion 23c is fitted into a front sidewall of the fixed contact holding portion 24.

Furthermore, the elastic plate portion 23d is composed of a relatively short inclined plate portion 23e extending obliquely from the distal end of the folded-back portion 23c to right downward and a contact plate portion 23f extending from a distal end of the inclined plate portion 23e in parallel with the contact base portion 23b.

As illustrated in FIG. 3, the fixed contact 23B is formed to be plane-symmetrical to the fixed contact 23A with respect to a vertical plane in a front-and-rear direction, and, as with the fixed contact 23A, includes the contact base portion 23b including the contact portion 23a, the folded-back portion 23c, and the elastic plate portion 23d composed of the inclined plate portion 23e and the contact plate portion 23f.

As illustrated in FIG. 3, the fixed contact 23C is formed to be line-symmetrical to the fixed contact 23A with respect to a horizontal line in a lateral direction, and, as with the fixed contact 23A, includes the contact base portion 23b including the contact portion 23a, the folded-back portion 23c, and the elastic plate portion 23d composed of the inclined plate portion 23e and the contact plate portion 23f.

The fixed contact 23D is, as illustrated in FIG. 3, formed to be plane-symmetrical to the fixed contact 23C with respect to the vertical plane in the front-and-rear direction, and, as with the fixed contact 23C, includes the contact base portion 23b including the contact portion 23a, the folded-back portion 23c, and the elastic plate portion 23d composed of the inclined plate portion 23e and the contact plate portion 23f.

The fixed contact holding portion 24 fixedly holds the fixed contacts 23A to 23D. The fixed contact holding portion 24 includes contact holding portions 24A, 24B, 24C, and 24D arranged at four places along both sides of the pair of fixed contact elements 11 and 12 of the main contact unit 10 and a contact support housing portion 24E housing the movable contact support 26 provided at a center of the contact holding portions 24A to 24D.

As illustrated in FIGS. 3 to 5, the contact holding portions 24A to 24D include a through-hole 24a holding the contact portion 23a of the fixed contacts 23A to 23D and extending laterally to pass through to the contact support housing portion 24E. On front and rear inner surfaces of the through-hole 24a are formed projections 24b and 24c projecting inward at a vertical center thereof and extending laterally. The projections 24b and 24c dividingly form an upper contact insertion portion 24d and a lower contact insertion portion 24e.

In the contact holding portions 24A and 24B, the contact base portion 23b of the fixed contacts 23A and 23B is inserted, with the contact portion 23a facing upward, into the lower contact insertion portion 24e, and the folded-back portion 23c is fitted into the front sidewall. Additionally, in the contact holding portions 24C and 24D, the contact base portion 23b of the fixed contacts 23C and 23D is inserted, with the contact portion 23a facing downward, into the upper contact insertion portion 24d, and the folded-back portion 23c is fitted into the rear sidewall. The contact portion 23a is caused to project in the contact support housing portion 24E in the state where the fixed contacts 23A and 23B are held in the contact holding portions 24A and 24B.

On front-and-rear side walls of the contact support housing portion 24E are formed recessed portions 24f and 24g guiding both ends of the movable contact support 26.

As illustrated in FIG. 3, the movable contact support 26 includes a flat rectangular cylindrical body 26a made of an electrically insulating material such as a synthetic resin and extending in the front-and-rear direction orthogonal to the movable contact element 13 of the main contact unit 10. At a center of the rectangular cylindrical body 26a in the front-and-rear direction is formed a partition wall 26b extending laterally to project from right and left end surfaces, whereby two contact housing chambers 26c and 26d are formed in the front-and-rear direction.

The contact housing chambers 26c and 26d individually hold the movable contacts 25A and 25B. The movable contact 25A is formed into a plate shape rectangular in plan view, in which a recessed plate portion 25a projecting downward is formed at a longitudinal center thereof, as illustrated in FIG. 4. The movable contact 25B is formed into a plate shape rectangular in plan view, in which a projecting plate portion 25b projecting upward formed at a longitudinal center thereof, as illustrated in FIG. 5.

Additionally, as illustrated in FIG. 4, the movable contact 25A is urged downward by a contact spring 27A so that a bottom surface of the recessed plate portion 25a thereof contacts with a lower plate portion of the contact housing chamber 26c. The movable contact 25B is urged upward by a contact spring 27B so that an upper surface of the projecting plate portion 25b thereof contacts with an upper plate portion of the contact housing chamber 26d, as illustrated in FIG. 5.

Then, by housing the movable contact support 26 in the contact support housing portion 24E, the movable contact 25A is separated upward from the contact portions 23a of the fixed contacts 23A and 23B, as illustrated in FIG. 4, and the movable contact 25B is contacted from below with the contact portions 23a of the fixed contacts 23C and 23D, as illustrated in FIG. 5. Accordingly, the fixed contacts 23A and 23B and the movable contact 25A form a first auxiliary contact mechanism 28A that serves as a make contact (a contact), and the fixed contacts 23C and 23D and the movable contact 25B form a second auxiliary contact mechanism 28B that serves as a break contact (b contact).

The terminal housing cylindrical portions 21b and 21c are formed by a rectangular cylindrical portion passing both side portions of the movable contact element 13 of the main contact unit 10 from the upper surface of the contact housing portion 21a and extending to near the upper surface plate portion 6b of the bottomed upper rectangular cylindrical body 6 forming the contact housing unit 5. In the terminal housing cylindrical portions 21b and 21c, a through-hole 21g passing through from the contact housing portion 21a to an upper end thereof is formed at each of positions facing distal ends of the elastic plate portions 23d of the fixed contacts 23A to 23D.

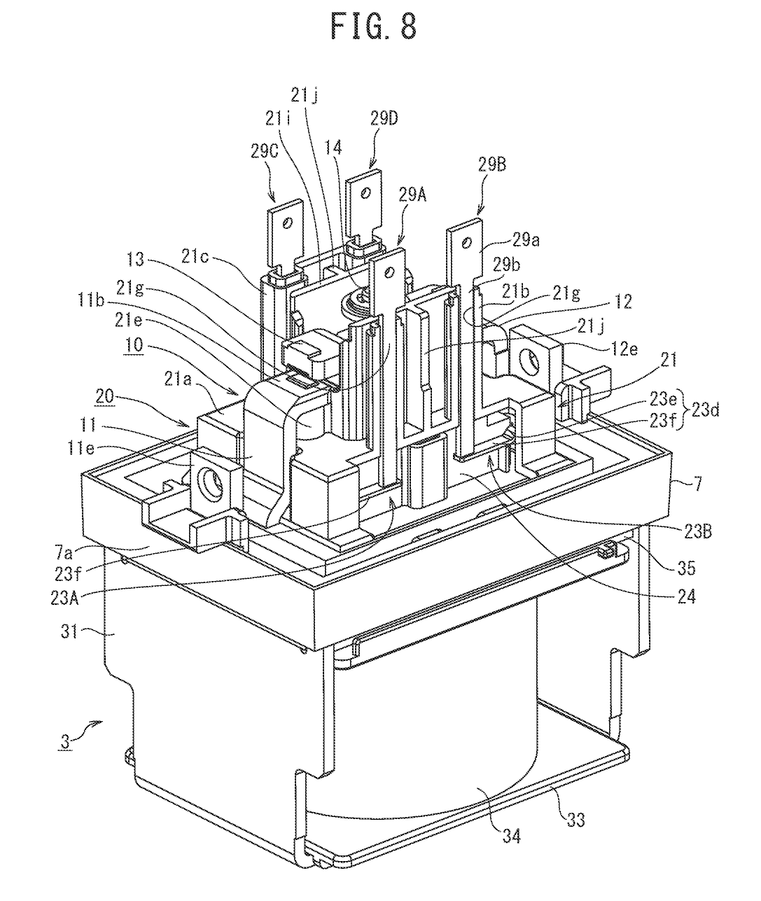

Additionally, external terminal connection terminals 29A to 29D, respectively, are connected to the elastic plate portions 23d of the fixed contacts 23A to 23D. Each of the external connection terminals 29A to 29D is made of a conductive metal. As illustrated in FIGS. 8 and 9, a wide terminal portion 29a as a head portion and an elongated plate portion 29b extending downward from a lower end center of the wide terminal portion 29a are integrally formed together.

In the external connection terminals 29A to 29D, as illustrated in FIG. 8, distal ends of the elongated plate portions 29b are caused to pass through the through-holes 21g in the terminal housing cylindrical portions 21b and 21c of the auxiliary contact case 21 via the through-holes 6c formed in the bottomed upper rectangular cylindrical body 6 forming the contact housing unit 5 and project into the contact housing portion 21a. Then, the contact plate portions 23f of the elastic plate portions 23d of the fixed contacts 23A to 23D are pressed downward, and in this state, an adhesive is filled around the through-holes 6c of the bottomed upper rectangular cylindrical body 6 to form a second adhesive layer 30, thereby fixing the external connection terminals 29A to 29D. Accordingly, the elastic plate portions 23d of the fixed contacts 23A to 23D and the external connection terminals 29A to 29D are electrically connected together in an elastic contact state.

In addition, between the fixed contact elements 11, 12 and the movable contact element 13 of the main contact unit 10 and the terminal housing cylindrical portions 21b and 21c are formed electrically insulating partition walls 21h and 21i that avoid influence of an arc generated when the fixed contact elements 11, 12 and the movable contact element 13 are open. On sides of the electrically insulating partition walls 21h and 21i facing the terminal housing cylindrical portions 21b and 21c is formed an electrically insulating projection 21j extending between the cylindrical portions forming the through-holes 21g into which the external connection terminals 29A to 29D are inserted.

The electromagnet unit 3 includes a lower magnetic yoke 31 having a U-shape as seen in side view, as illustrated in FIG. 2, and a fixed plunger 32 is arranged at a center of a bottom plate portion of the lower magnetic yoke 31. Then, a spool 33 is arranged outside the fixed plunger 32.

As illustrated in FIG. 2, the spool 33 includes a central circular cylindrical portion 33a into which the fixed plunger 32 is inserted, a lower flange portion 33b projecting radially outward from a lower end of the central circular cylindrical portion 33a, and an upper flange portion 33c projecting radially outward from an upper end of the central circular cylindrical portion 33a.

Then, an excitation coil 34 is wound in a housing space formed by the central circular cylindrical portion 33a, the lower flange portion 33b, and the upper flange portion 33c of the spool 33.

A plate-shaped magnetic yoke 35 is fixed to an upper end as an open end of the lower magnetic yoke 31. A bottom surface of the bottomed lower rectangular cylindrical body 7 forming the contact housing unit 5 is tightly fixed to an upper surface of the magnetic yoke 35. Additionally, at a center of the magnetic yoke 35 is formed a movable plunger through-hole 35a.

A cap 36 formed into a bottomed cylindrical shape is arranged on an upper part of the fixed plunger 32 arranged in the central circular cylindrical portion 33a of the spool 33, and a flange portion 36a provided at an open end of the cap 36 and projecting radially outward is seal-bonded to a lower surface of the magnetic yoke 35. In this way, the sealed contact device 2 is formed in which the contact housing unit 5 and the cap 36 are communicated together via the movable plunger through-hole 35a of the magnetic yoke 35.

Inside the cap 36 is housed the movable plunger 37 in a vertically movable manner. The movable plunger 37 includes a circular cylindrical portion 37a housed to be vertically movable in the cap 36 and a circumferential flange portion 37b provided at an upper end of the circular cylindrical portion 37a and projecting radially outward. The circular cylindrical portion 37a of the movable plunger 37 is vertically inserted into the movable plunger through-hole 35a of the magnetic yoke 35, and the circumferential flange portion 37b of the movable plunger 37 has a larger outer diameter than the movable plunger through-hole 35a and is located above the magnetic yoke 35.

In the circular cylindrical portion 37a of the movable plunger 37 is formed a return spring housing recessed portion 37c extending upward from a lower end surface thereof. Between a bottom portion of the cap 36 and an upper end surface of the return spring housing recessed portion 37c is arranged a return spring 38 that urges the movable plunger 37 upward.

As illustrated in FIGS. 1 and 2, a ring-shaped permanent magnet 39 being rectangular in outer shape and having a circular central opening is fixed to an upper surface of the magnetic yoke 35 so as to surround the circumferential flange portion 37b of the movable plunger 37. The permanent magnet 39 is magnetized such that, in a vertical direction, i.e., in a thickness direction, for example, an upper end side thereof has an N-pole, and a lower end side thereof has an S-pole.

An auxiliary yoke 40 being same in outer shape as the permanent magnet 39 and having a through-hole 40a with a smaller inner diameter than the circumferential flange portion 37b of the movable plunger 37 is fixed to an upper surface of the permanent magnet 39. The connecting shaft 14 is vertically inserted into the through-hole 40a.

Here, the sealed contact housing unit 5 housing the contact mechanism 4, the connecting shaft 14, and the movable plunger 37 is formed by the plate-shaped magnetic yoke 35 having the movable plunger through-hole 35a into which the movable plunger 37 is vertically inserted, the contact housing unit 5 bonded to the upper surface of the magnetic yoke 35 and housing the contact mechanism 4 thereinside, and the cap 36 bonded to the lower surface of the magnetic yoke 35 and housing the movable plunger 37 thereinside. The sealed contact housing unit 5 encloses an arc extinguishing gas such as, e.g., hydrogen.

Next, operation of the electromagnetic contactor 1 of the first embodiment will be described.

First, assume that the terminal portion 11e of the fixed contact element 11 is connected to a power supply source that supplies, for example, large current, and the terminal portion 12e of the fixed contact element 12 is connected to a load.

In this state, assume that the excitation coil 34 of the electromagnet unit 3 is in a non-excited state, and the electromagnetic contactor 1 is in a released state where no excitation force for moving down the movable plunger 37 is generated in the electromagnet unit 3.

In this released state, the movable plunger 37 is urged by the return spring 38 in an upper direction where the circumferential flange portion 37b is separated from the magnetic yoke 35. Simultaneously with this, an attracting force due to magnetic force of the permanent magnet 39 acts on the auxiliary yoke 40 to attract the circumferential flange portion 37b of the movable plunger 37. Due to this, an upper surface of the circumferential flange portion 37b of the movable plunger 37 is in contact with a lower surface of the auxiliary yoke 40.

Accordingly, the movable contacts 13d and 13e of the movable contact element 13 forming the main contact unit 10 of the contact mechanism 4 and connected to the movable plunger 37 via the connecting shaft 14 are spaced away by a determined distance upward from the fixed contact 11a of the fixed contact element 11 and the fixed contact 12a of the fixed contact element 12. Thus, a current path between the fixed contact elements 11 and 12 is in an open state, causing the contact mechanism 4 to be in a released state.

On the other hand, in the auxiliary contact unit 20, since the movable plunger 37 is moved upward by the return spring 38, the connecting shaft 14 connected to the movable plunger 37 is also moved upward. Due to this, the movable contact support 26 connected to the connecting shaft 14 is moved upward, as illustrated in FIG. 4. Accordingly, in the first auxiliary contact mechanism 28A, the movable contact 25A is separated upward from the fixed contacts 23A and 23B, as illustrated in FIG. 4, so that the contact mechanism 28A goes into a normally open state where there is electrical discontinuity between the fixed contacts 23A and 23B. Conversely, in the second auxiliary contact mechanism 28B, the movable contact 25B is caused to contact with the fixed contacts 23C and 23D by contact pressure of the contact spring 27, as illustrated in FIG. 5, so that the contact mechanism 28B goes into a normally closed state where there is electrical continuity between the fixed contacts 23C and 23D.

Thus, in the fixed contacts 23A and 23B of the first auxiliary contact mechanism 28A, the contact base portion 23b having the contact portion 23a formed thereon is connected to the elastic plate portion 23d arranged outside a front sidewall of the fixed contact holding portion 24 via the folded-back portion 23c. The distal end of the elongated plate portion 29b of the external connection terminals 29A and 29B is in elastic contact with the elastic plate portion 23d of the fixed contacts 23A and 23B via the through-hole 6c formed in the bottomed upper rectangular cylindrical body 6 forming the contact housing unit 5 and the through-hole 21g of the terminal housing cylindrical portion 21b formed in the auxiliary contact case 21.

Then, by connecting an operation detecting circuit for detecting a connection state of the main contact unit 10 to the wide terminal portions 29a at upper ends of the external connection terminals 29A and 29B, it can be detected that the first auxiliary contact mechanism 28A is in an open state, and the main contact unit 10 is in an open state.

Similarly, in the fixed contacts 23C and 23D of the second auxiliary contact mechanism 28B, the contact base portion 23b having the contact portion 23a formed thereon is connected to the elastic plate portion 23d arranged outside a rear sidewall of the fixed contact holding portion 24 via the folded-back portion 23c. The distal end of the elongated plate portion 29b of the external connection terminals 29C and 29D is in elastic contact with the elastic plate portion 23d of the fixed contacts 23C and 23D via the through-hole 6c formed in the bottomed upper rectangular cylindrical body 6 forming the contact housing unit 5 and the through-hole 21g of the terminal housing cylindrical portion 21b formed in the auxiliary contact case 21.

Accordingly, by connecting a connection detecting circuit for detecting the connection state of the main contact unit 10 to the wide terminal portions 29a at upper ends of the external connection terminals 29C and 29D, it can be detected that the second auxiliary contact mechanism 28B is in a closed state, and the main contact unit 10 is in the open state.

When, in the released state, current is applied to the excitation coil 34 of the electromagnet unit 3, an excitation force is generated in the electromagnet unit 3 to push the movable plunger 37 downward against an urging force of the return spring 38 and the attracting force of the permanent magnet 39. The descent of the movable plunger 37 is stopped when the lower surface of the circumferential flange portion 37b abuts against the upper surface of the magnetic yoke 35.

Thus, as the movable plunger 37 descends, the movable contact element 13 connected to the movable plunger 37 via the connecting shaft 14 also descends, whereby each of the movable contacts 13d and 13e of the movable contact element 13 of the contact mechanism 4 is contacted with each of the fixed contact 11a of the fixed contact element 11 and the fixed contact 12a of the fixed contact element 12 by contact pressure of the contact spring 15.

Due to this, the main contact unit 10 goes into a closed state in which the large current of the power supply source is supplied to the load through the fixed contact element 11, the movable contact element 13, and the fixed contact element 12.

In the closed state of the main contact unit 10, the movable contact 25A of the first auxiliary contact mechanism 28A is contacted with the fixed contacts 23A and 23B, whereby the contact mechanism 28A goes into a closed state. This provides electrical continuity between the external connection terminals 29A and 29B, so that the closed state of the main contact unit 10 can be detected by the detecting device connected between the external connection terminals 29A and 29B. Similarly, in the second auxiliary contact mechanism 28B, the movable contact 25B is separated downward from the fixed contacts 23C and 23D, whereby the contact mechanism 28B goes into an open state. This breaks electrical continuity between the external connection terminals 29C and 29D, so that the closed state of the main contact unit 10 can be detected by the detecting device connected between the external connection terminals 29C and 29D.

In this case, the first auxiliary contact mechanism 28A and the second auxiliary contact mechanism 28B are arranged in the contact housing portion 21a of the auxiliary contact case 21 arranged below the movable contact element 13 of the main contact unit 10, whereby the main contact unit 10 and the auxiliary contact unit 20 are surely electrically insulated with respect to each other, thus enabling prevention of malfunction of the first auxiliary contact mechanism 28A and the second auxiliary contact mechanism 28B. Additionally, since the external connection terminals 29A to 29D pass through insides of the terminal housing cylindrical portions 21b and 21c and reach an upper end side of the contact housing unit 5, electrical insulation with respect to the movable contact element 13 the main contact unit 10 can be ensured.

Then, to stop current supply to the load from the closed state of the contact mechanism 4, energization to the excitation coil 34 of the electromagnet unit 3 is stopped.

When energization to the excitation coil 34 is stopped, there is lost the excitation force for moving the movable plunger 37 downward by the electromagnet unit 3, as a result of which the movable plunger 37 ascends due to urging force of the return spring 38, and the attracting force of the permanent magnet 39 increases as the circumferential flange portion 37b becomes closer to the auxiliary yoke 40.

Along with the ascent of the movable plunger 37, the movable contact element 13 connected thereto via the connecting shaft 14 ascends. During a time when contact pressure is applied by the contact spring 15 in response to this, each of the movable contacts 13d and 13e of the movable contact element 13 is in contact with each of the fixed contact 11a of the fixed contact element 11 and the fixed contact 12a of the fixed contact element 12. After that, when the contact pressure of the contact spring 15 ceases, the contact mechanism 4 goes into the open state where the movable contact element 13 is separated upward from the fixed contact elements 11 and 12.

In such an open state, electric arcs are generated between the movable contacts 13d and 13e of the movable contact element 13 and the fixed contact 11a of the fixed contact element 11 and the fixed contact 12a of the fixed contact element 12, and cause an electrically conductive state to be continued.

Then, the electric arcs generated between the movable contacts 13d and 13e of the movable contact element 13 and the fixed contact 11a of the fixed contact element 11 and the fixed contact 12a of the fixed contact element 12 are extended by a Lorentz force generated by the Fleming's left hand rule from a relationship between a flow of current in these electric arcs and a magnetic flux generated by an unillustrated arc extinguishing permanent magnet, and are cooled and extinguished by the arc extinguishing gas enclosed in the contact housing units. Accordingly, the fixed contact elements 11 and 12 become open, and the main contact unit 10 returns to the released state. Upon the generation of the electric arcs, the auxiliary contact unit 20 is not affected by the electric arcs and can surely maintain electrical insulation, since the first auxiliary contact mechanism 28A and the second auxiliary contact mechanism 28B are surrounded by the contact housing portion 21a of the auxiliary contact case 21, and the external connection terminals 29A to 29D are also surrounded by the terminal housing cylindrical portions 21b and 21c and the electrically insulating partition walls 21h and 21i.

When the main contact unit 10 returns to the released state in this way, the movable contact 25A is separated upward from the fixed contacts 23A and 23B, whereby the first auxiliary contact mechanism 28A also goes into the open state where the external communication terminals 29A and 29B are electrically disconnected from each other, enabling detection of return of the main contact unit 10 to the released state. Similarly, the movable contact 25B contacts with the fixed contacts 23C and 23D, whereby the second auxiliary contact mechanism 28B goes into the closed state where the external connection terminals 29C and 29D are electrically connected to each other, enabling detect of return of the main contact unit 10 to the released state.

However, due to the electric arcs generated in the main contact unit 10 when switching from the closed state to the open state, the movable contact element 13 may be welded to the fixed contact elements 11 and 12. In this case, when the energization to the excitation coil 34 of the electromagnet unit 3 is stopped and an attempt is made to move the movable plunger 37 upward by the return spring 38, the ascent of the connecting shaft 14 is hindered due to the welding of the movable contact element 13 to the fixed contact elements 11 and 12.

For this reason, in the first auxiliary contact mechanism 28A, the movable contact support 26 does not ascend, whereby the movable contact 25A remains in contact with the fixed contacts 23A and 23B, and the external connection terminals 29A and 29B remain electrically connected to each other. Accordingly, by detecting the electrical continuity state between the external connection terminals 29A and 29B by the operation detecting device and confirming the stop of the energization to the excitation coil 34, the occurrence of the welding in the main contact unit 10 can be surely detected.

Similarly, in the second auxiliary contact mechanism 28B also, as the movable contact support 26 does not ascend, the movable contact 25B remains separated downward from the fixed contacts 23C and 23D, and the external connection terminals 29C and 29D remain electrically disconnected from each other. Accordingly, by detecting the electrical discontinuity state between the external connection terminals 29C and 29D by the operation detecting device and confirming the stop of the energization to the excitation coil 34, the occurrence of the welding in the main contact unit 10 can be surely detected.

Thus, according to the above first embodiment, since the movable contact element 13 of the main contact unit 10 and the movable contacts 25A P 25B of the auxiliary contact unit 20 are directly connected to the connecting shaft 14 that serves as a movable shaft, the movable state of the main contact can be surely detected in the auxiliary contact unit, so that the occurrence of a welded state in the main contact unit 10 can be surely detected.

Moreover, regardless of the location of the auxiliary contact unit 20 below the main contact unit 10, the external connection terminals 29A to 29D can be drawn out from upper parts of the contact housing unit 5 via both sides of the main contact unit 10, thus facilitating connection of wires to the auxiliary contact unit 20.

The external connection terminals 29A to 29D are inserted into the terminal housing cylindrical portions 21b and 21c provided on the auxiliary contact case 21, and thus are not affected by electric arcs generated in the main contact unit 10, and electrical insulation can be ensured. Furthermore, by forming the electrically insulating partition walls 21h and 21i between the terminal housing cylindrical portions 21b and 21c and the fixed contact elements 11, 12 and the movable contact element 13 and the terminal housing cylindrical portions 21b and 21c, influence of electric arcs can be further prevented and electrical insulation can be further ensured.

Additionally, in the auxiliary contact unit 20, the movable contact support 26 is connected to the connecting shaft 14. The movable contact support 26 is arranged in the direction orthogonal to the movable contact element 13 of the main contact unit 10, and, in the movable contact support 26, the two movable contacts 25A and 25B are arranged to be parallel with the movable contact element 13. Thus, the structure of the auxiliary contact unit 20 can be miniaturized, thereby enabling miniaturization of the auxiliary contact-equipped contact device, and also enabling miniaturization of an electromagnetic contactor including the contact device.

Additionally, the auxiliary contact unit 20 includes the first auxiliary contact mechanism 28A and the second auxiliary contact mechanism 28B. Thus, by forming one of the mechanisms as a make contact and the other one thereof as a break contact, the state of operation of the main contact unit 10 can be surely detected.

Furthermore, by forming the fixed contacts 23A to 23D of the auxiliary contact unit 20 into the U-shape, connection with the external connection terminals 29A to 29D can be made in a direction orthogonal to the movable contact element 13 of the main contact unit 10. This makes it unnecessary to provide contact portions for the external connection terminals in a longitudinal direction of the contact device 2, i.e., in a direction in which the movable contact element 13 extends. Thus, a longitudinal length of the contact device can be reduced, thus enabling contribution to miniaturization.

Furthermore, for electrical connections between the fixed contacts 23A to 23D of the auxiliary contact unit 20 and the external connection terminals 29A to 29D, the external connection terminals 29A to 29D may be pressed against and contacted with the elastic plate portions 23d formed in the fixed contacts 23A to 23D. Thus, assembly of the contact device 2 can be facilitated, and assembly of an electromagnetic contactor using the contact device 2 can also be facilitated.

In addition, the sealed contact housing unit 5 can be easily formed by filling an adhesive into a bonding portion between the bottomed upper rectangular cylindrical body 6 and the bottomed lower rectangular cylindrical body 7 the contact housing portion 5, filling the adhesive around the external connection terminals 29A to 29D projecting from the upper surface of the bottomed upper rectangular cylindrical body 6, and covering the movable plunger 37 that moves the connecting shaft 14 with the cap 36. This ensures enclosure of an arc extinguishing gas that is applied when interposing the contact device in a high current path, so that leakage of the arc extinguishing gas can be surely prevented.

### Second Embodiment

Next, a second embodiment of the present invention will be described with FIGS. 10 to 12.

The second embodiment is configured such that the electrical connections between the fixed contacts of the auxiliary contact unit and the external connection terminals are more surely made.

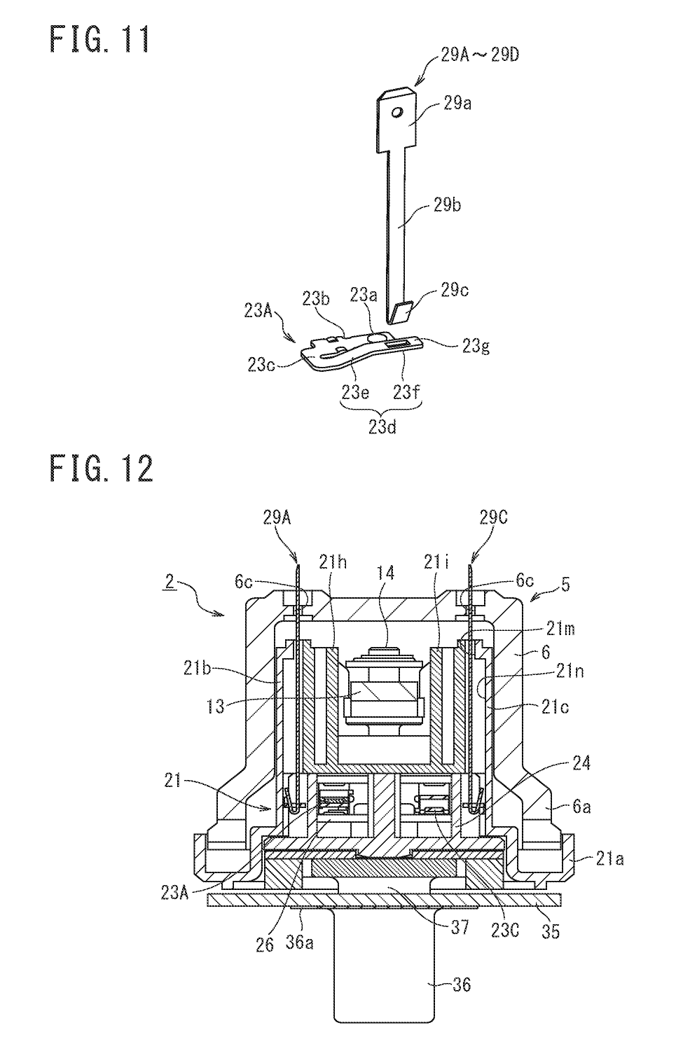

Specifically, in the second embodiment, in the contact plate portion 23f of the elastic plate portion 23d of each of the fixed contacts 23A to 23D of the auxiliary contact unit 20 is formed an engagement hole 23g in which the external connection terminals 29A to 29D are each engaged, as illustrated in FIG. 11.

In accordance with this, the external connection terminals 29A to 29D are formed by using a conductive spring material, and at the distal end of the elongated plate portion 29b is formed an elastic folded-back portion 29c having a V-shape in side view by folding back the distal end upward.

Then, as illustrated in FIG. 12, each of the through-holes 21g of the terminal housing cylindrical portions 21b and 21c in which the external connection terminals 29A to 29D are inserted has, at an upper end thereof, an opening portion 21m having a narrow cross-sectional shape into which the folded-back portion of each of the external connection terminals 29A to 29D is pushed in a folded state, and has an insertion portion 21n having a wide cross-sectional shape ranging from the opening portion 21m to a lower end side opening portion to the contact housing portion 21a.

Other structures are the same as those of the first embodiment described above. Portions corresponding thereto are denoted by the same reference signs and detailed description thereof will be omitted.

According to the second embodiment, when electrically connecting the external connection terminals 29A to 29D to the elastic plate portions 23d of the fixed contacts 23A to 23D of the auxiliary contact unit 20, the external connection terminals 29A to 29D are inserted into the through-holes 6c of the bottomed upper rectangular cylindrical portion 6 in a state where the folded-back portions 29c are folded by being pressed onto the elongated plate portion 29b side against elasticity, as illustrated in FIG. 10. In this state, the external connection terminals 29A to 29D are pushed in downward, whereby when the folded-back portions 29c in the folded state pass through the opening portions 21m of the terminal housing cylindrical portions 21b and 21c and reach the wide insertion portions 21n from the opening portions 21m, the folded-back portions 29c return to an original form thereof by their own elasticity. When the external connecting terminals 29A to 29D are further pushed therein, the folded-back portions 29c enter into the contact housing portion 21a and are engaged in the engagement holes 23g of the fixed contacts 23A to 23D. At this time, by setting a spring constant of the fixed contacts 23A to 23D to be larger than a spring constant of the folded-back portions 29c of the external connection terminals 29A to 29D, the folded-back portions 29c are inserted into the engagement holes 23g while bending.

Due to this, the fixed contacts 23A to 23D are connected in an elastic contact state, so that steady contact pressure can be obtained and also contact area can be increased, as compared with the contact by elasticity of the elastic plate portions 23d of the fixed contacts 23A to 23D of the first embodiment described above.

### Third Embodiment

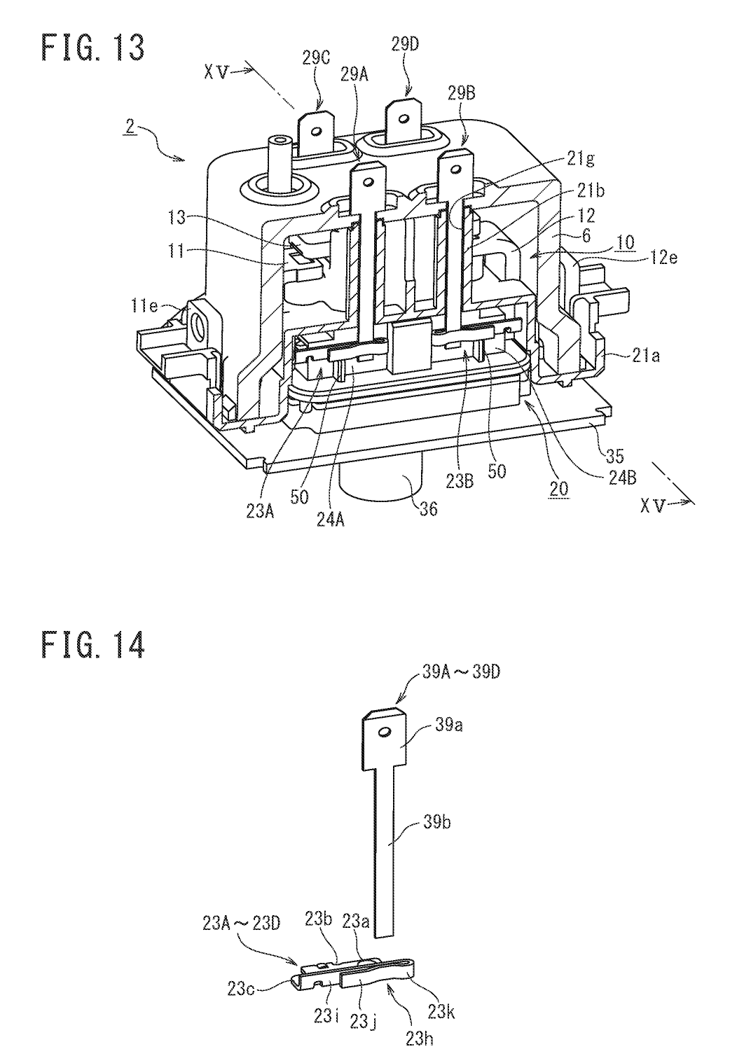

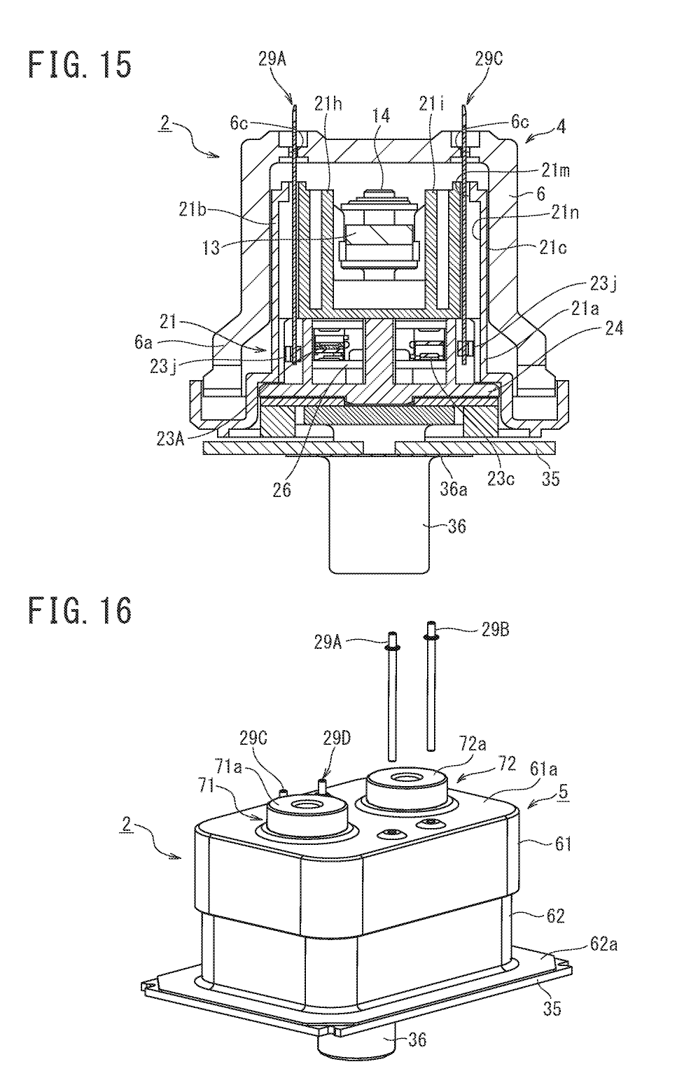

Next, a third embodiment of the contact device according to the present invention will be described with FIGS. 13 to 15.

The third embodiment is configured such that electrical connections between the fixed contacts of the auxiliary contact unit and the external connection terminals are made more strongly, as with the second embodiment described above.

Specifically, in the third embodiment, in the fixed contacts 23A to 23D of the auxiliary contact unit 20, the elastic plate portion 23d in the first embodiment and the second embodiment is omitted, as illustrated in FIG. 14. Instead of that, at the folded-back portion 23c is formed a clip portion 23h that clips the distal ends of the elongated plate portions 29b of the external connection terminals 29A to 29D.

As illustrated in FIG. 14, the clip portion 23h includes a first plate portion 23i bent upward by the folded-back portion 23c and extending in parallel with the contact base portion 23b and a clip plate portion 23j folded back from a distal end of the first plate portion 23i and extending along the first plate portion 23i. Here, on the clip plate portion 23j is formed a press portion 23k by contacting a position facing the distal end of the elongated plate portion 29b of the respective external connection terminals 29A to 29D with the first plate portion 23i or making the position face the portion 23i at a slight distance therefrom. Additionally, lower surface sides of longitudinal intermediate portions of the first plate portion 23i and the clip plate portion 23j are supported by a support piece 50 formed at a bottom plate portion of the contact housing portion 21a, as illustrated in FIG. 13.

Other structures are the same as those in the first embodiment described above. Portions corresponding to those of the first embodiment are denoted by the same reference signs and detailed description thereof will be omitted.

According to the third embodiment, electrical connections between the fixed contacts 23A to 23D of the auxiliary contact unit 20 and the external connection terminals 29A to 29D are made, as in the first embodiment described above, by inserting the distal ends of the long plate portions 29b of the external connection terminals 29A to 29D from the through-holes 6c formed in the bottomed upper rectangular cylindrical body 6 of the contact housing unit 5.

Furthermore, the distal ends of the elongated plate portions 29b are pushed into the contact housing portion 21a through the through-holes 21g of the terminal housing cylindrical portions 21b and 21c. Since the clip portions 23h are supported by the support pieces 50, the distal ends of the elongated plate portions 29b move downward while forcibly pushing the press portions 23k of the clip plate portions 23j of the clip portions 23h of the fixed contacts 23A to 23D in a direction away from the first plate portions 23i. Then, the distal ends of the elongated plate portions 29b project below the press portions 23k in a state where the lower surfaces of the wide terminal portions 29a of the external connection terminals 29A to 29D are in contact with the upper surface of the bottomed upper rectangular cylindrical body 6.

Accordingly, the elongated plate portions 29b are clipped by being pressed toward the first plate portions 23i side by the pressing portions 23k of the clip portions 23h, so that electrical connections between the fixed contacts 23A to 23D and the external connection terminals 29A to 29D can be more surely made.

After that, the second adhesive layer 30 is formed by filling and solidifying an adhesive around the through-holes 6c formed in the bottomed upper rectangular cylindrical body 6 the wide terminal portions 29a of the external connection terminals 29A to 29D, whereby sealing of the contact housing unit 5 and fixing of the external connection terminals 29A to 29D are simultaneously performed.

According to the third embodiment, since the distal ends of the elongated plate portions 29b of the external connection terminals 29A to 29D are clipped by the clip portions 23h formed in the fixed contacts 23A to 23D of the auxiliary contact portion 20, electrical connections between the fixed contacts 23A to 23D and the external connection terminals 29A to 29D can be made more strongly.

### Fourth Embodiment

Next, a fourth embodiment of the contact device according to the present invention will be described with FIGS. 16 to 18.

The fourth embodiment is configured such that fixed contact elements of the main contact unit are arranged on a top plate portion of the contact housing unit, as with the external connection terminals of the auxiliary contact unit.

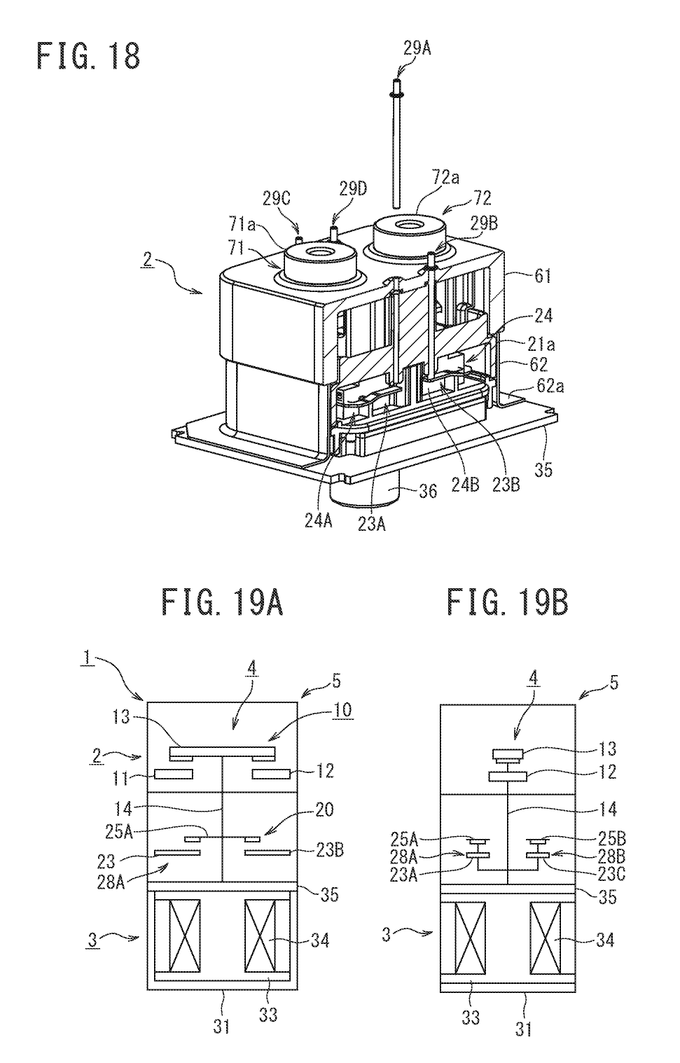

Specifically, as illustrated in FIGS. 16 and 18, the structure of the auxiliary contact unit 20 in the fourth embodiment is the same as that in the first embodiment, except that the external connection terminals 29A to 29D are formed into a bar shape having a circular cross section.

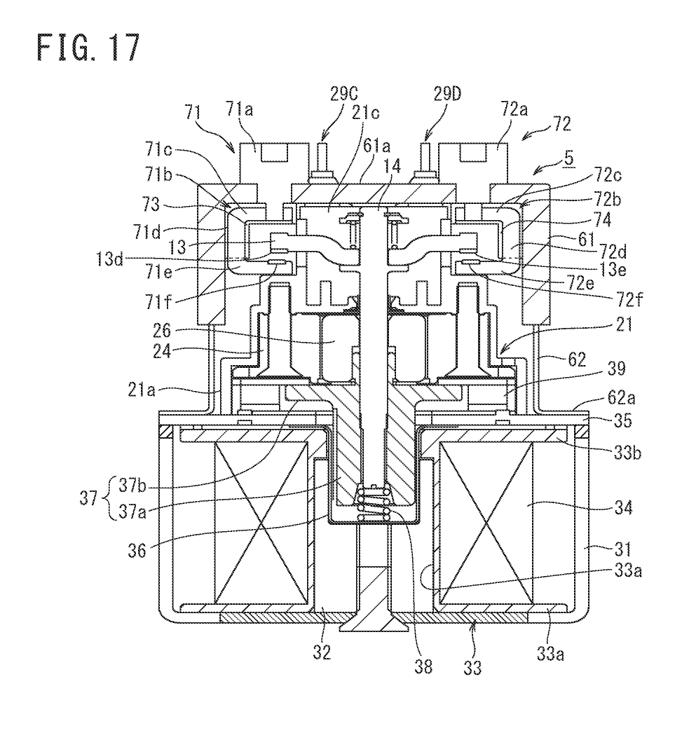

On the other hand, as illustrated in FIG. 17, the contact housing unit 5 includes a bottomed rectangular cylindrical body 61 made of, e.g., ceramic and having an open lower side and a metallic rectangular cylindrical body 62 seal-bonded to a lower end surface of the bottomed rectangular cylindrical body 61. At a lower end of the metallic rectangular cylindrical body 62 is formed a circumferential flange portion 62a projecting outward. The circumferential flange portion 62a is seal-bonded to the magnetic yoke 35.

Additionally, in the main contact portion 10, a pair of fixed contact elements 71 and 72 is arranged at a predetermined distance from each other in a longitudinal direction on a top plate portion 61a of the bottomed rectangular cylindrical body 61. The fixed contact elements 71 and 72 includes connection terminal portions 71a and 72a projecting on an upper surface of the top plate portion 61a and contact holding portions 71b and 72b connected to the connection terminal portions 71a and 72a on a lower surface side of the top plate portion 61a.

Each of the contact holding portions 71b and 72b is formed into a C-shape having an open inner side by upper plate portions 71c and 72c extending to lateral side wall sides of the bottomed rectangular cylindrical body 61 along the top plate portion 61a, middle plate portions 71d and 72d extending downward from ends of the lateral side wall sides of the upper plate portions 71c and 72c along the lateral side walls, and contact plate portions 71e and 72e extending in parallel with the upper plate portions 71c and 72c from lower ends of the middle plate portions 71d and 72d in directions away from lateral side wall portions. The contact plate portions 71e and 72e include fixed contacts 71f and 72f formed on distal end side upper surfaces thereof. Additionally, electrical insulation covers 73 and 74 are arranged so as to cover inner peripheral surfaces and front and rear side surfaces of the upper plate portions 71c and 72c and the middle plate portions 71d and 72d.

Then, both ends of the movable contact element 13 are extended between the upper plate portions 71c and 72c and the contact plate portions 71e and 72e of the contact holding portions 71b and 72b, and the movable contacts 13d and 13e are formed on lower surfaces facing the fixed contacts 71f and 72f of the fixed contact elements 71 and 72.

Other structures of the main contact unit 10 are the same as those in the first embodiment. Portions corresponding to those of the first embodiment are denoted by the same reference signs, and detailed description thereof will be omitted.

According to the fourth embodiment, although the main contact unit 10 is structurally changed from that of the first embodiment, positional relationships between the movable contacts 13d and 13e formed on the movable contact elements 13 and the fixed contacts 71f and 72f of the contact plate portions 71e and 72e of the fixed contact elements 71 and 72 are the same as those of the first embodiment, so that operation of the main contact unit 10 is the same as the operation of the first embodiment.

Similarly, since the auxiliary contact unit 20 is also the same in structure as that of the first embodiment, the operation of the auxiliary contact unit 20 is also the same as the operation of the first embodiment.

However, in the fourth embodiment, the fixed contact elements 71 and 72 forming the main contact unit 10 are arranged on the top plate portion 61a of the bottomed rectangular cylindrical body 61 forming the contact housing unit 5, and the connection terminal portions 71a and 72a are arranged on the upper surface of the top plate portion 61a. Thus, on the upper surface of the contact housing unit 5 are arranged the connection terminal portions 71a and 72a of the main contact unit 10 and connection terminal portions of the external connection terminals 29A to 29D of the auxiliary contact unit 20.

Accordingly, wiring to the main contact unit 10 and the auxiliary contact unit 20 to the electromagnetic contactor can be formed on the top plate portion 61a of the bottomed rectangular cylindrical body 61, thus enabling facilitation of wiring connection. In this case, by forming the external connection terminals 29A to 29D of the auxiliary contact unit 20 into a bar-shape having a circular cross section, an electrical insulation distance with respect to the connection terminal portions 71a and 72a of the fixed contact elements 71 and 72 of the main contact unit 10 can be maintained longer than when forming the external connection terminals 29A to 29D into a plate shape.

While the first to fourth embodiments of the present invention have been described hereinabove, the invention is not limited thereto, and various changes and alterations can be made.

For example, the contact housing unit 5 of the first to third embodiments may be formed by a bottomed rectangular cylindrical body and a metallic rectangular cylindrical body, as in the fourth embodiment, or only the top plate may be an electrically insulating plate, and a metallic rectangular cylindrical body may be seal-bonded to a lower surface of the electrically insulating plate.

Similarly, in the fourth embodiment, the contact housing unit 5 may include a bottomed upper rectangular cylindrical body and a bottomed lower rectangular cylindrical body, as in the first to third embodiments.

In addition, while the first to fourth embodiments have described the case in which the movable contact element 13 of the main contact unit 10 and the movable contacts 25A and 25B of the auxiliary contact unit 20 are arranged to be parallel with each other, the invention is not limited thereto. The movable contacts 25A and 25B may be arranged in a direction orthogonal to or intersecting with the movable contact element 13. In this case, arrangements of the fixed contacts 23A to 23D and the external connection terminals 29A to 29D may be changed according to arrangement positions of the movable contacts 25A and 25B.

Additionally, while the first to fourth embodiments have described the case in which the movable contacts of the movable contact element of the main contact unit 10 are caused to contact with and separate from the fixed contacts of the fixed contact elements from above, the invention is not limited thereto. The movable contacts of the movable contact element may be configured to contact with and separate from the fixed contacts of the fixed contact elements from below. In this case, the flange portion, the contact spring, the spring receiver, and the E ring for use to mount the movable contact element to the connecting shaft 14 may be arranged upside down, the movable plunger may be arranged on a lower side of an inside of the cap 36 of the electromagnet unit 3, the fixed plunger may be arranged with respect to the movable plunger via the return spring, and the connecting shaft connected to the movable plunger may be caused to project upward through a central opening of the fixed plunger. Furthermore, the movable contacts and the fixed contacts of the first auxiliary contact mechanism 28A and the second auxiliary contact mechanism 28B of the auxiliary contact unit 20 may be arranged in an upside-down relationship.

According to the above structure, when the excitation coil 34 is in a non-conductive state, the movable plunger abuts against a bottom surface of the cap 36 therebelow by the return spring. By energizing the excitation coil 34 in this state, the movable plunger is suctioned by the fixed plunger against the return spring and moved upward. Thereby, the connecting shaft 14 ascends to cause the movable contacts of the movable contact element to contact with the fixed contacts of the fixed contact elements, so that the same advantageous effects as those of the first to fourth embodiments can be obtained.

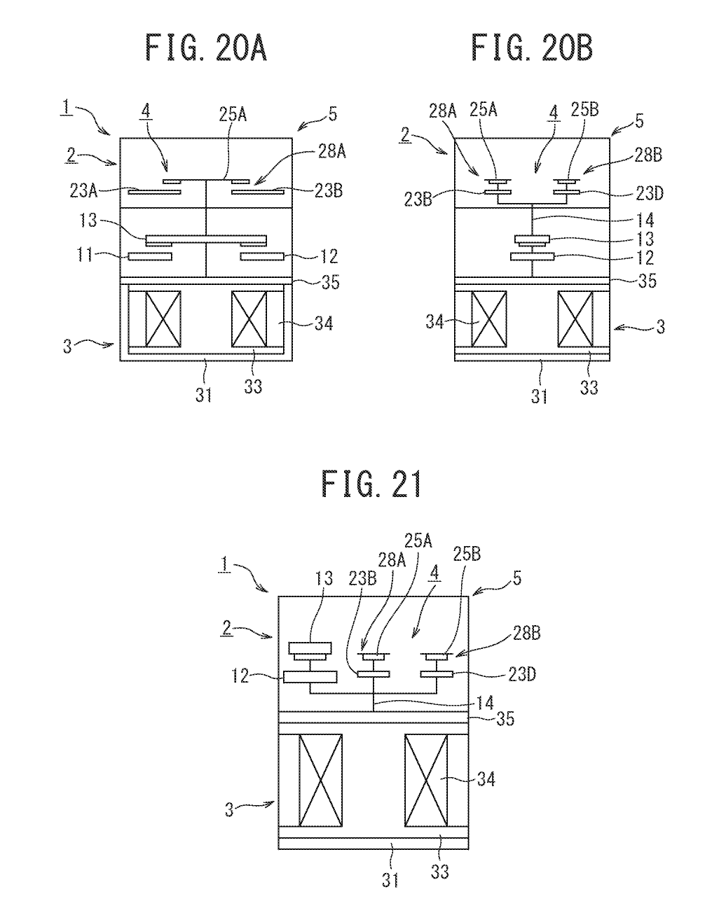

Additionally, the first to fourth embodiments have described the case in which, as schematically illustrated in FIGS. 19A and 19B, the main contact unit 10 is arranged on an upper side of the connecting shaft 14, and the auxiliary contact unit 20 is arranged on a lower side of the connecting shaft in series therewith. However, the present invention is not limited to the above structure. As illustrated in FIGS. 20A and 20B, the auxiliary contact unit 20 can be arranged on the upper side of the connecting shaft 14, and the main contact unit 10 can be arranged on the lower side thereof in series therewith. Furthermore, as illustrated in FIG. 21, the main contact unit 10 and the first auxiliary contact mechanism 28A and the second auxiliary contact mechanism 28B of the auxiliary contact unit 20 may be arranged in parallel on the connecting shaft 14.

Additionally, while the first to fourth embodiments have described the case in which the auxiliary contact 20 includes the make contact and the break contact, the invention is not limited thereto. The auxiliary contact unit 20 can include two make contacts or two break contacts.

### REFERENCE SIGNS LIST

1: Electromagnetic contactor

2: Contact device

3: Electromagnet unit

4: Contact mechanism

5: Contact housing unit

6: Bottomed upper rectangular cylindrical body

6a: Extended cylindrical portion

6b: Upper surface plate portion

6c: Through-hole

7: Bottomed lower rectangular cylindrical body

10: Main contact unit

11, 12: Fixed contact element

13: Movable contact element

14: Connecting shaft

20: Auxiliary contact unit

21: Auxiliary contact case

21a: Contact housing portion

21b, 21c: Terminal housing cylindrical portion

21h, 21i: Electrically insulating partition wall

22: Auxiliary contact mechanism

23A to 23D: Fixed contact

25A, 25B: Movable contact

26: Movable contact support

28A: First auxiliary contact mechanism

28B: Second auxiliary contact mechanism

29A to 29D: External connection terminal

29a: Wide terminal portion

29b: Elongated plate portion

31: Lower magnetic yoke

32: Fixed plunger

33: Spool

34: Excitation coil

35: Magnetic yoke

36: Cap

37: Movable plunger

38: Return spring

61: Bottomed rectangular cylindrical body

62: Metallic rectangular cylindrical body

71, 72: Fixed contact element

1. A contact device comprising:
a main contact unit including a pair of fixed contact elements arranged at a predetermined distance from each other and a movable contact element elastically supported by a movable shaft and arranged to be contactable with and separable from the pair of fixed contact elements;
an auxiliary contact unit arranged at a position different from the main contact unit and including a pair of fixed contacts arranged at a predetermined distance from each other and a movable contact connected to the movable shaft and arranged to be contactable with and separable from the pair of fixed contacts;
a contact housing unit configured to house the main contact unit and the auxiliary contact unit; and
an external connection terminal electrically connected to each of the pair of fixed contacts of the auxiliary contact unit and projecting from the contact housing unit.

2. The contact device according to claim 1, wherein the auxiliary contact unit includes a movable contact support configured to hold the movable contact fixed to the movable shaft, the movable contact support elastically supporting the movable contact at a position shifted in an axial direction of the movable shaft with respect to the movable contact element.

3. The contact device according to claim 2, wherein the auxiliary contact unit is held by an electrically insulating contact holding portion configured to fixedly hold the pair of fixed contacts in such a manner that the fixed contacts face each other, and the movable contact support is arranged in the contact holding portion.

4. The contact device according to claim 3, wherein each of the pair of fixed contacts of the auxiliary contact unit is formed into a U-shape by a first conductive plate portion configured to contact with the movable contact, a second conductive plate portion configured to be connected to the external connection terminal, and a connecting plate portion configured to connect the first conductive plate portion and the second conductive plate portion.

5. The contact device according to claim 4, wherein the first conductive plate portion is fixedly held with a distal end of the first conductive plate portion facing the movable contact in the contact holding portion, and the second conductive plate portion is arranged outside the contact holding portion via a sidewall of the contact holding portion.

6. The contact device according to claim 4, wherein the second conductive plate portion includes an inclined portion extending from the connecting plate portion and a contact plate portion extending in parallel with the first conductive plate portion from the inclined portion to be contacted with the external connection terminal.

7. The contact device according to claim 4, wherein the external connection terminal is in elastic contact with the second conductive plate portion of each of the pair of fixed contacts.

8. The contact device according to claim 7, wherein the external connection terminal is bar-shaped.

9. The contact device according to claim 4, wherein the external connection terminal includes an elastic folded-back portion to be engaged in an engagement hole formed in the second conductive plate portion of each of the pair of fixed contacts.

10. The contact device according to claim 4, wherein the external connection terminal is formed on the second conductive plate portion of each of the pair of fixed contacts and clipped by an elastic clip portion.

11. The contact device according to claim 5, wherein the contact holding portion is dividedly formed in the axial direction of the movable shaft.

12. The contact device according to claim 3, wherein the contact holding portion and the external connection terminal are incorporated in an electrically insulating auxiliary contact case.

13. The contact device according to claim 2, wherein the movable contact support elastically holds two movable contacts, and a pair of fixed contacts is arranged facing both ends of each of the movable contacts to form two auxiliary contact mechanisms.

14. The contact device according to claim 13, wherein the movable contact support includes a partition wall extending in a direction in which the movable contact element extends, and the two movable contacts are elastically held via the partition wall.

15. The contact device according to claim 13, wherein one of the two auxiliary contact mechanisms forms a make contact, and the other one of the two auxiliary contact mechanisms forms a break contact.

16. The contact device according to claim 1, wherein the contact housing unit includes a bottomed cylindrical body including a top plate portion having a through-hole formed at an upper part of the portion to allow the external connection terminal to project and a cylindrical portion configured to cover a circumference of the top plate portion and a lid body including a bottom plate portion configured to close an open end of the bottomed cylindrical body and a circumferential flange portion formed on an outer circumferential edge of the bottom plate portion to cover an open end side of the cylindrical portion from outside, in which a first adhesive layer is formed to bond the bottomed cylindrical body and the lid body together, and a second adhesive layer is formed to seal the through-hole in a state where the external connection terminal is caused to project.

17. The contact device according to claim 1, wherein a connection terminal portion of the main contact unit and a connection terminal potion of an external connection terminal portion of the auxiliary contact unit are arranged on an upper surface of the contact housing unit.

18. The contact device according to claim 16, wherein an arc-extinguishing gas is enclosed in the contact housing unit.

19. An electromagnetic contactor comprising the contact device according to claim land includes an electromagnet unit in which the movable shaft is connected to a movable iron core to move the movable iron core.

20. The electromagnetic contactor according to claim 19, wherein the electromagnet unit includes a fixed iron core facing the movable iron core, an excitation coil wound around the fixed iron core, and a magnetic yoke surrounding an outer circumferential side of the excitation coil, the movable iron core connected to the movable shaft being arranged in a through-hole formed at a center of an upper magnetic yoke forming the magnetic yoke, and a circumference of the movable iron core being covered with a sealing cap.
